(19) United States
(12) Patent Application Publication
(10) Pub. No.: US 2010/0282553 A1
(43) Pub. Date: Nov. 11, 2010

(54) ROTARY DAMPER HAVING IMPROVED BRAKING FEATURES

(76) Inventor: Antonino Cultraro, Rivoli (Torino) (IT)

Correspondence Address: HAYES SOLOWAY P.C., 3450 E. SUNRISE DRIVE, SUITE 140, TUCSON, AZ, 85718, US

(21) Appl. No.: 12/809,915

(22) PCT Filed: Dec. 31, 2007
(86) PCT No.: PCT/IT2007/000932

§ 371 Date: Jun. 21, 2010

(51) Int. Cl. F16D 57/00

(52) U.S. Cl. 188/290

(57) ABSTRACT

A rotary damping device (10) includes a housing (12) comprising a radially inner wall (17), a radially outer wall (18) and an end wall (19), which delimit a chamber (16) containing a viscous braking fluid; and a rotor (14), rotationally connected to the housing and mounted thereon on the opposite side to the end wall (19) so as to close the chamber (16). The rotor comprises a braking portion (27) having the form of an annular collar which extends axially inside the chamber (16) and is arranged between the radially inner wall (17) and the radially outer wall (18) of the housing (12). The radially inner wall (17) of the housing (12) has, formed therein, at least one recess (31) facing the braking portion (27) of the rotor (14) and able to interrupt the circular profile of the radially inner wall (17) inside the chamber (16).

The present invention relates to a rotary damping device, of the type including:
a housing comprising a radially inner wall, a radially outer wall and an end wall, which delimit a chamber containing a viscous braking fluid, and
a rotor, rotationally connected to said housing and mounted thereon on the opposite side to the end wall so as to close said chamber, said rotor comprising a braking portion having the form of an annular collar which extends axially inside the chamber and is arranged between the radially inner wall and the radially outer wall of the housing.

A device of this type is known, for example, from the German utility model DE 296 04 260 U1, which describes a pivoting handle provided with a grip hinged on a mounting wall of a vehicle. The grip is rotatable against the action of resilient means from a rest position, adjacent to the mounting wall, into an operating position. The grip is brought back automatically from the operating position into the rest position after release by the user. The return movement into the rest position is made smoother by a braking device, of the type defined in the introduction, which acts on the axis of rotation of the grip.

It has been established that the braking performance of the damping devices of this type may be subject to a certain lack of uniformity over time. It has in fact been noted that, in conditions of repeated use, the braking torque tends to decrease from an initial value to a given stabilization value. The duration of the rest period between successive uses appears to influence the rate of said decrease.

The object of the present invention is to provide a rotary damping device with compact dimensions, which is able to overcome the problems described above.

This object is achieved according to the invention by a rotary damping device of the type defined in the introduction, in which the radially inner wall of the housing has, formed therein, at least one recess facing the braking portion of the rotor and able to interrupt the circular profile of the radially inner wall inside the chamber.

In such a device, the recess(es) formed in the radially inner wall of the housing behave substantially in the manner of one or more reservoirs which allow temporary storage of viscous fluid, causing the generation of turbulence in the fluid between the radially inner wall of the housing and the braking portion of the rotor. The deterioration in the braking performance of conventional devices in fact appears to be associated with the formation of parallel fluid layers between the radially inner wall of the housing and the braking portion of the rotor, which results in a gradual reduction in the viscous friction acting on the braking portion of the rotor. By avoiding the formation of these parallel fluid layers, a deterioration in the braking performance is prevented.

Preferred embodiments of the invention are defined in the dependent claims.

Further characteristic features and advantages of the device according to the invention will become clear from the following detailed description of an embodiment of the invention, with reference to the accompanying drawings, provided purely by way of a non-limiting example in which:

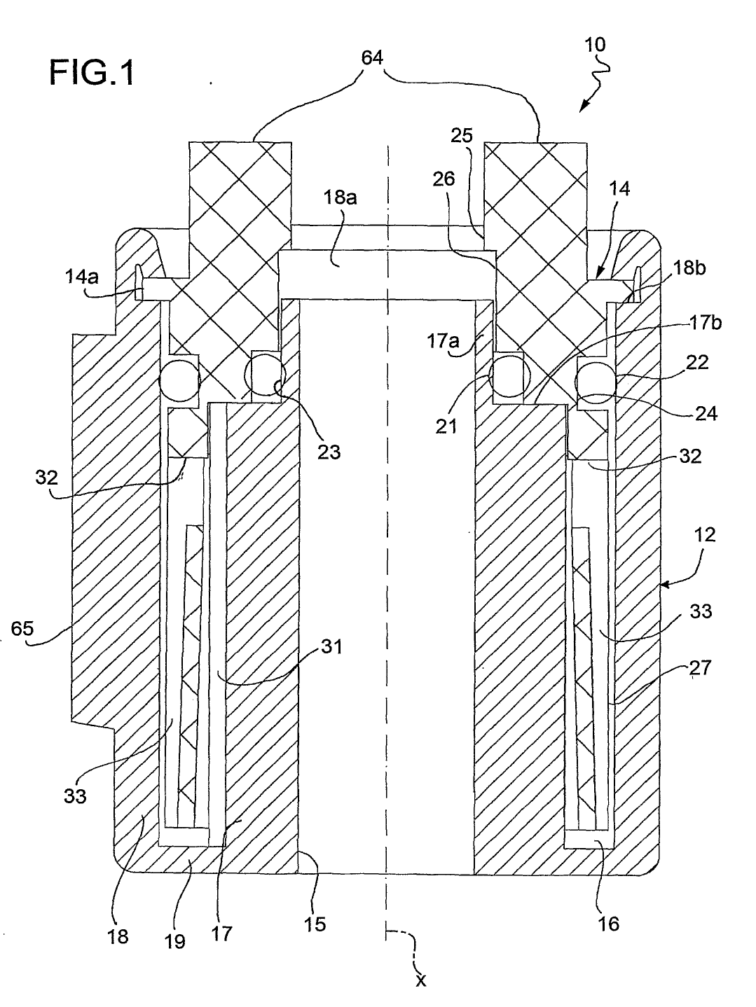

FIG. 1 is a cross-sectional view of a rotary damping device according to the invention;

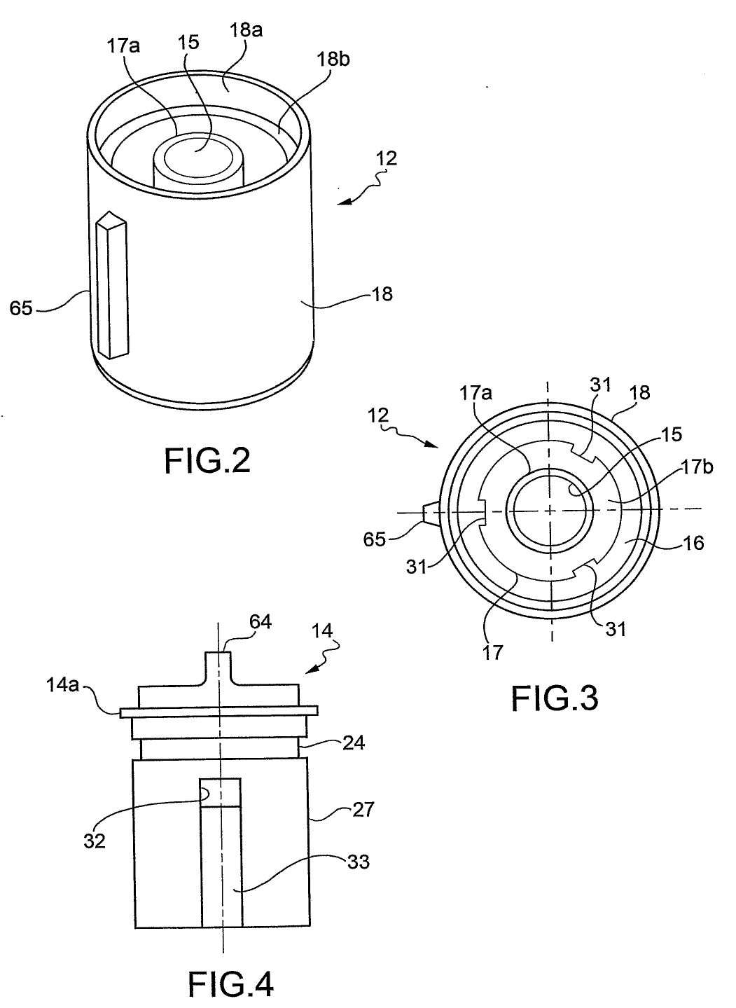

FIG. 2 is a perspective view of a housing of the damping device according to FIG. 1, prior to assembly;

FIG. 3 is a plan view of the housing according to FIG. 2; and

FIG. 4 is a side elevation view of a rotor of the damping device according to FIG. 1.

The figures show a rotary damping device—denoted overall by 10—suitable for being mounted, for example, inside a pivoting handle, mounted on a wall inside a passenger compartment of a vehicle, of the type where the grip of the handle is rotatable against the action of resilient means from a rest position into an operating position. However, the type of application is not to be regarded as limiting the invention in any way.

The device 10 comprises a housing 12 on which a rotor 14 rotatable about an axis x is mounted. The housing 12 is substantially cylindrical and has a central through-opening 15 which allows assembly of the device on the axis of rotation of a movable member such as the handle described in the utility model DE 296 04 260 U1.

As can be seen in the figures, the housing 12 defines an annular chamber 16 coaxial with the central opening 15 and containing a viscous fluid, for example silicone oil. The annular chamber 16 is delimited laterally by a radially inner wall 17 and by a radially outer wall 18 and is closed at one end by an end wall 19.

The end of the annular chamber 16 opposite to the end wall 19 is open and at this end the radially outer wall 18 has an edge with a mouth 18a, the radially outer wall 18 being folded inwards, for example by means of hot or ultrasound riveting. In a position adjacent to the mouth 18a, a shoulder 18b is formed on the inner surface of the radially outer wall 18.

With this arrangement, the housing 12 retains axially the rotor 14 so that the latter is able to close the annular chamber 16. The rotor 14 has in fact a flange 14a which is formed on its radially outer surface and is intended to be axially engaged between the shoulder 18b and the folded mouth 18a of the housing 12. Obviously, the method of assembly of the rotor 14 on the housing 12 is not essential for the purposes of the invention, provided that it allows relative rotation of them.

The tightness of the closure of the annular chamber 16 is ensured by a pair of O-rings 21, 22. One O-ring 21 is housed inside a corresponding seat 23 formed in the radially inner wall 17 of the housing 12 and is arranged between this radially inner wall 17 and a radially inner surface of the rotor 14 so as to form a radial seal. The other O-ring 22 is housed inside a corresponding seat 24 formed in the radially outer surface of the rotor 14 and is arranged between this radially outer surface and the radially outer wall 18 of the housing 12 so as to form a radial seal.

The alignment and centering of the rotor 14 with respect to the chamber 16 of the housing 12 is ensured by the side walls 17 and 18 of the housing 12. In particular, the radially inner wall 17 of the housing 12 defines the rotational shaft of the rotor 14. More precisely, the rotational shaft of the rotor 14 is defined by a top portion 17a of the radially inner wall 17 of the housing 12, which has an outer diameter smaller than the outer diameter of the remaining part of the radially inner wall 17. The rotor 14 has, formed in it, a through-hole 25 intended to receive coaxially the movable member to which the device 10 is connected. This through-hole 25 has a cross-section 26 with a greater diameter intended to receive the top part 17a of the radially inner wall 17 of the housing 12 acting as a rotational shaft. A shoulder surface 17b which forms an abutment surface for the rotor 14 is defined between the top part 17a and remaining part of the radially inner wall 17.

The rotor 14 also comprises a braking portion 27 having the form of an annular, cylindrical or slightly frustoconical collar which extends axially inside the chamber 16 and is arranged between the radially inner wall 17 and the radially outer wall 18 of the housing 12. Respective interspaces which are filled with viscous fluid are thus defined between the radially inner wall 17 and the braking portion 27 and between the radially outer wall 18 and the braking portion 27. The braking portion may be formed as one piece with the rotor 14 or may be produced separately and then fastened to it in a conventional manner, for example mechanically.

During rotation of the rotor 14 with respect to the housing 12, the viscous friction associated with the movement of the braking portion 27 of the rotor 14 inside the chamber 16 is the cause of the braking action provided by the damping device 10.

At least one recess 31 facing the braking portion 27 of the rotor 14 is formed on the radially inner wall 17 of the housing 12, or better, on the part of this wall facing the chamber 16. In the preferred embodiment shown in the figures, three recesses 31 formed as longitudinal grooves are envisaged, these extending axially along the whole part of the radially inner wall 17 facing the chamber 16 and being arranged uniformly at intervals in the circumferential direction. The recesses 31 are able to interrupt the circular profile of the radially inner wall 17 inside the chamber 16. The recesses 31 thus arranged behave substantially in the manner of reservoirs which allow the temporary accumulation or stagnation of viscous fluid, causing the generation of turbulence in the fluid between the radially inner wall 17 of the housing 12 and the braking portion 27 of the rotor 14. This prevents the formation of parallel fluid layers between the radially inner wall of the housing and the braking portion of the rotor, thus ensuring that the braking efficiency of the device remains uniform over time.

Preferably, in order to further improve the braking performance of the damping device, the wall of the braking portion 27 of the rotor 14 has, formed therein, radial through-openings 32 which allow the viscous fluid to pass from the radially inner side to the radially outer side of the braking portion 27, and vice versa, and therefore help prevent the formation of parallel fluid layers. This effect is further improved by forming recesses 33 on the radially outer side of the wall of the braking portion 27. Preferably, these recesses 33 are formed as grooves extending axially from the through-openings 32 towards the free end of the braking portion 27. In the example shown, there are two through-holes 32 which are arranged in diametrically opposite positions of the braking portions 27 and with which two grooves 33 are associated.

The device according to the invention is preferably made of plastic. It may not envisage the presence of the central through-hole 15, instead making use of outer engaging systems and/or blind shaped holes, resulting in a smaller radial volume.

The type of connection of the device to the bodies between which a braking action of the relative movement is to be obtained may be of any type known to the person skilled in the art, depending on the different applicational requirements. In the examples shown in the figures, the characteristic features to be used for the connection are achieved in a manner similar to that described in the German utility model DE 296 04 260 U1. Namely, the front side of the rotor 14, emerging from the housing 12, has two tongues 64 extending in diametrically opposite radial directions, while the radially outer wall 18 of the housing 12 has a tongue 65 extending in the axial direction of the housing 12. These tongues 64 and 65 are intended to engage with corresponding mounting seats (not shown) formed respectively in the two members with respect to which the relative movement is to be braked. The device in the embodiment described above is intended to be arranged along the axis of rotation of one of these members with respect to the other one. However, it is possible to devise other arrangements of the device, depending on the type of application: for example an arrangement where a gearwheel is fastened to the rotor and this gearwheel engages with a rack fastened to a movable member, the movement of which must be slowed down, adopting a configuration of the type which is normally used for example in doors or drawers.

1-5. (canceled)

6. A rotary damping device comprising:
a housing comprising a radially inner wall, a radially outer wall and an end wall, which delimit a chamber containing a viscous braking fluid, and
a rotor, rotationally connected to said housing and mounted thereon on the opposite side to the end wall so as to close said chamber, said rotor comprising a braking portion having the form of annular collar which extends axially inside the chamber and is arranged between the radially inner wall and the radially outer wall of the housing,
wherein the radially inner wall of the housing has, formed therein, at least one recess facing the braking portion of the rotor and able to interrupt the circular profile of the radially inner wall inside the chamber,
wherein the radially outer wall of the housing has a riveted, inwardly folded mouth and a shoulder formed on an inner surface of the radially outer wall, the rotor having a flange which is formed on a radially outer surface of the rotor and is axially engaged between the shoulder and the inwardly folded mouth of the radially outer wall so that the rotor is axially retained by the housing.

7. The damping device according to claim 6, wherein said at least one recess comprises a plurality of longitudinal grooves extending axially along the whole part of the radially inner wall facing the chamber and arranged uniformly at intervals in the circumferential direction.

8. The damping device according to claim 6, wherein at least one radial through-opening is formed in the braking portion of the rotor.

9. The damping device according to claim 6, wherein at least one recess is formed on the radially outer side of the braking portion of the rotor.

10. The damping device according to claim 8, wherein at least one recess is formed on the radially outer side of the braking portion of the rotor.

11. The damping device according to claim 10, wherein said at least one opening comprises a plurality of openings and said at least one recess comprises a plurality of grooves extending axially from the openings to the free end of the braking portion of the rotor.

12. The damping device according to claim 7, wherein at least one radial through-opening is formed in the braking portion of the rotor.

13. The damping device according to claim 7, wherein at least one recess is formed on the radially outer side of the braking portion of the rotor.

14. The damping device according to claim 12, wherein at least one recess is formed on the radially outer side of the braking portion of the rotor.

15. The damping device according to claim 14, wherein said at least one opening comprises a plurality of openings and said at least one recess comprises a plurality of grooves extending axially from the openings to the free end of the braking portion of the rotor.
